(19) United States
(12) Patent Application Publication
(10) Pub. No.: US 2025/0335956 A1
(43) Pub. Date: Oct. 30, 2025

(54) Placing an Advertisement on a Web Page

(71) Applicant: P. Variablis GmbH, Geldern (DE)

(72) Inventor: Torsten Zühlsdorff, Geldern (DE)

(21) Appl. No.: 19/188,751

(22) Filed: Apr. 24, 2025

(30) Foreign Application Priority Data
Apr. 26, 2024 (DE) 10 2024 111 877.6

(51) Int. Cl. G06Q 30/0241; G06Q 30/0242

(52) U.S. Cl. CPC G06Q 30/0277; G06Q 30/0243; G06Q 30/0244

(57) ABSTRACT

A computer-implemented method for placing an advertisement on a web page includes capturing at least a portion of the respective content of a plurality of web pages; transforming the captured content of the web pages to obtain a content description of each respective web page; creating web page groups that contain web pages with content descriptions that are similar to each other to at least a predetermined degree; placing the same advertisement on a plurality of web pages of a first web page group and a second web page group; capturing the number of clicks on the advertisement across the plurality of web pages of the first and second web page groups within a predetermined time period; comparing the number of clicks on the advertisement across the web pages of the first web page group with those of the second web page group; and continuing to use the advertisement on the web pages of the web page group with the higher number of clicks, and discontinuing its use on the web pages of the group with the lower number of clicks.

The present application is based upon and claims the right of priority to DE Patent Application No. 102024 111 877.6, filed Apr. 26, 2024, the disclosure of which is hereby incorporated by reference herein in its entirety for all purposes.

The invention relates to a computer-implemented method for placing an advertisement on a web page.

Selecting a suitable advertisement for a user visiting a particular subpage of a website is a challenging task. Websites consist of numerous subpages, each targeting a specific audience. The effectiveness of advertisements is greatest when they are tailored to the audience of a subpage and presented within the context of that subpage's content. The core challenge in selecting suitable advertisements lies in the need for several crucial pieces of information: first, the content and message of the advertisement should be clearly defined. Second, the context of the visited web page should be determined, which can be difficult due to the diversity and complexity of content. Third, detailed information about the visitor—such as interests, age, and purchasing behavior—should be available.

However, several limitations hinder the acquisition of such information. The contents of advertisements may be unknown; processing images and videos can be time-consuming; and sometimes the formats that can be processed are less effective, such as plain text. Additionally, supplementary data such as the advertisement's position on the web page or loading times may exceed processing capabilities. The context of a web page—especially in the case of news sites—can be difficult to determine and is often very diverse. Moreover, the need to obtain consent in accordance with the General Data Protection Regulation (GDPR) in the EU for collecting visitor data significantly complicates the task and can greatly reduce the effectiveness of traditional methods without such consent. These challenges illustrate how complex it is to determine a suitable advertisement for the current user on a specific subpage.

The problem of finding a suitable advertisement for a currently visited web page with its specific content for the current user with their specific interests thus encompasses several complex challenges: modern advertising systems should have access to a wide variety of data sources, including user behavior data, browsing history, demographic data, and information about previous interactions with advertisements. These data should be processed and analyzed in real time to serve relevant ads, which requires significant technological infrastructure. Furthermore, the advertisement should not only be relevant to the user but also fit within the context of the visited web page. The challenge lies in finding advertising content that aligns with both the user's interests and the topic of the web page, in order to avoid dissonance and improve the user experience.

User interests can be multifaceted and dynamic, making it difficult to precisely identify a user's current interests. Advertising systems should also be capable of learning from past interactions and combining that information with the current context to accurately determine current interests.

As mentioned above, using user data to personalize advertisements can also be problematic in terms of data protection and privacy. Compliance with data protection laws (such as the GDPR in the European Union) and ensuring user acceptance through transparent practices are crucial to building trust and avoiding legal risks. Additionally, the increasing use of ad blockers by users makes it more difficult to display advertisements at all. Even when an ad is displayed, there is no guarantee that the user will notice it. Finding creative and acceptable ways to present advertisements without disrupting the user experience remains an ongoing challenge. Measuring and enhancing the effectiveness of advertisements is therefore difficult and complex. It's not only about whether a user clicks on an ad but also about the long-term impact on brand image and purchasing decisions. Advertisers must continuously test and analyze data to improve performance.

Moreover, the internet is a constantly evolving space where trends and user interests can change rapidly. A n advertising system must therefore be flexible enough to dynamically adapt to these changes and continuously deliver improved advertisements. As a result, selecting the most appropriate advertisement for a particular user on a specific web page requires a careful balance between relevance, user acceptance, data protection, and technological efficiency in order to both enhance the user experience and achieve advertising objectives.

US 2004/0059708 A1 describes a system and method for delivering context-based advertising on web pages. It explains how relevant ads can be selected and placed based on the content of a web page, which corresponds to the fundamental principle behind AdSense. US 2005/0108232 A1 discloses a method for enhancing ad delivery by considering user interactions and other parameters to maximize ad effectiveness. US 2006/0242075 A1 addresses methods for analyzing web page content to select appropriate ads, presenting an algorithm that evaluates a page's content and assigns suitable advertisements. US 2008/0077465 A1 describes a system for managing advertising budgets and bids in real time, allowing advertisers to efficiently control spending and enhancing ad placement. US 2009/0112714 A1 discloses a method for improving ad click-through rates by adjusting ad design and placement based on user behavior and preferences.

Furthermore, US 2024/0086975 A1 describes the capture, generation, distribution, and management of online web content. The devices, systems, and methods described therein can be used to collect and generate online web content and communication. In particular, the devices and systems described can be used to create one or more marketing and/or advertising campaigns and to monitor, manage, and define the efficiency, effectiveness, and feasibility of the campaign in terms of generating user engagement, thereby accurately determining the cost advantages of the campaign. The provided analytics can then be used to steer the generation of original web content, for example, to enhance the customer or follower experience, promote the business, and conduct advertising campaigns. Alternatively, publicly available web content that has proven successful may be reproduced, referenced, or otherwise used in connection with the promotion or presentation of the user's web content.

A major drawback of the approaches described above is that meeting these requirements has, until now, only been possible with considerable computational power and memory resources.

Based on this, the objective of the invention is to provide a method for placing an advertisement on a web page that can be executed using fewer resources.

This objective is achieved by the subject matter of claim 1. Preferred embodiments are found in the dependent claims.

According to the invention, a computer-implemented method for placing an advertisement on a web page is provided, including the following method steps:

Capturing at least part of the respective content of a plurality of web pages,
transforming the captured content of the web pages to obtain a content description of each respective web page,
creating web page groups that include web pages with such content descriptions that are similar to each other at least to a predetermined degree,
placing the same advertisement on a plurality of web pages of a first web page group and a second web page group,
capturing the number of clicks on the advertisement on the plurality of web pages of the first web page group and capturing the number of clicks on the advertisement on the plurality of web pages of the second web page group within a predetermined period of time,
comparing the number of clicks on the advertisement on the plurality of web pages of the first web page group with the number of clicks on the advertisement on the plurality of web pages of the second web page group, and
continuing to use the advertisement on the plurality of web pages of the web page group for which the higher number of clicks was recorded, and discontinuing the use of the advertisement on the plurality of web pages of the web page group for which the lower number of clicks was recorded.

The current disclosure refers to the same advertisement being placed on a plurality of web pages of a first web page group and a second web page group. However, the invention is not limited to the use of only a single advertisement on each web page. Rather, a plurality of advertisements may also be used. In such cases, the number of advertisements must also be known in addition to the number of clicks in order to calculate a click-through rate.

The invention takes advantage of the following observation: typically, individual subpages do not have enough visitors to draw statistically significant conclusions about the advertisements displayed on them. However, for the topics of nearly all subpages, there usually exist other web pages with similar content. By forming virtual groups of thematically similar content and/or by forming virtual groups for thematically similar advertisements, cross-group testing of advertisement effectiveness can be conducted.

The method according to the invention—particularly the use of grouping without user data—offers several significant advantages. In conventional methods, very large amounts of personal data must be collected. Without this data collection, such data is no longer required. This significantly reduces storage requirements, as personal data and its history no longer need to be stored. The required storage capacity thus correlates only with the number of web pages and is accordingly finite. In conventional methods, historical data on user behavior must be maintained, and this data may grow indefinitely in technical terms. In addition, the reduction in the volume of data to be processed results in significantly lower memory consumption. Moreover, simplifying the data structure also simplifies and accelerates computation. This is largely due to the fact that virtual groups are less structurally complex and more uniform than heterogeneous tracking events involving arbitrary personal data, as used in conventional methods.

Computation can be further accelerated if such data structures are processed by GPUs, which are known to operate significantly faster than CPUs. GPU computing, also known as General-Purpose Computing on Graphics Processing Units (GPGPU), refers to the use of graphics processors (GPUs) for general computing tasks beyond traditional graphics rendering. The use of GPUs can improve performance for suitable tasks by orders of magnitude compared to CPU-only solutions. GPU computing has thus become a critical factor in fields that require the processing of large data volumes or complex calculations, accelerating research and development in many scientific and technical domains. Originally designed for complex graphics applications and rendering in video games, GPUs feature an architecture characterized by high parallelism. This makes them particularly efficient for the types of algorithms required by the present invention, which must perform many operations on data sets simultaneously. Unlike central processing units (CPUs), which consist of a few high-frequency cores adapted for sequential processing, GPUs contain hundreds or thousands of cores that can simultaneously work on different parts of a problem. This characteristic makes GPUs especially well-suited for parallelizable computations such as those required in the context of the present invention.

Capturing at least part of the content of a plurality of web pages may, for example, be performed using a web crawler, via an API, or in another suitable manner.

Terminology in the Context of the Present Invention:

An online presence, such as a sales platform, news site, or blog, is referred to herein as a website. This website typically contains a plurality of subpages, referred to here as web pages. These web pages have content, such as text and images, which can be described, for example, using categories. Thus, each web page can be assigned a description of its individual content, i.e., parts of its content such as a specific text section, but also a description of its overall content.

A web crawler, also known as a spider or search bot, is an automated program that scans the internet to find and index web pages. The process of crawling is fundamental for search engines like Google, Bing, or Yahoo, as it enables them to discover new content and update existing content to create a comprehensive database of web pages that can be searched. Web crawlers typically begin with a list of web page addresses from previous crawling operations and so-called sitemaps provided by website operators. From these starting points, they follow the links on the pages to discover new pages. While crawling, they collect information from each web page—such as text content, meta tags, and hyperlinks to other pages. This information is then stored in an index, which forms the basis for the search engine's results.

Crawlers are usually designed to scan the web efficiently and respectfully. They adhere to the rules defined in the “robots.txt” file on web servers to understand which parts of a web page should not be crawled. These rules help prevent server overload and ensure that sensitive or irrelevant information is not included in the search engine index. In essence, web crawlers make the internet searchable and accessible by continuously collecting and updating data that serves as the basis for further processing.

According to a preferred embodiment of the invention, the following steps are performed at least pairwise for a plurality of web pages:
placing the same advertisement on a plurality of web pages of a first web page group and a second web page group,
capturing the number of clicks on the advertisement on the plurality of web pages of the first web page group and capturing the number of clicks on the advertisement on the plurality of web pages of the second web page group,
comparing the number of clicks on the advertisement on the plurality of web pages of the first web page group with the number of clicks on the advertisement on the plurality of web pages of the second web page group, and
continuing to use the advertisement on the plurality of web pages of the web page group for which the higher number of clicks was recorded, and discontinuing the use of the advertisement on the plurality of web pages of the web page group for which the lower number of clicks was recorded.

When it is stated herein that the method in question is carried out “at least pairwise for a plurality of web pages,” this means that not only two web pages can be compared with one another, but that comparisons can also be made between more than two web pages. A subset of these pages can then be selected for continued use of the advertisement, while the advertisement is discontinued on the other pages. In other words, according to a preferred embodiment of the invention, a plurality of advertisements are tested to determine whether they are well received by the user group of a certain type of web page, with only the successfully received advertisements being retained.

The transformation of the captured content of the web pages to obtain a content description of each respective web page can be performed in various ways. Preferably, this transformation is carried out using a large language model.

Furthermore, the content description of each web page is preferably represented by assigning a vector from a predetermined vector space, wherein linearly independent vectors represent such web pages whose content descriptions are not similar to one another.

The degree of similarity between the content descriptions of two web pages is preferably determined by comparing embeddings (word embeddings). Determining the similarity of texts using the creation and comparison of embeddings is based on representing words, sentences, or entire documents as vectors in a high-dimensional space. These vector representations encapsulate the semantic meaning of text units in a way that allows mathematical analysis of their similarities and relationships.

The creation of embeddings is preferably performed using machine learning methods, particularly those based on neural networks. These methods learn from large amounts of text data by, for example, trying to predict a word based on its context or vice versa. Through this learning process, the models develop internal representations of words as vectors, with similar words receiving similar vector representations. This means that words with similar meanings or used in similar contexts are located close together in vector space.

Once texts are represented as vectors, their similarity can be determined using various mathematical techniques—most commonly by computing the cosine of the angle between their vectors (cosine similarity). The idea is that the more similar the meaning or context of two texts is, the smaller the angle between their vectors in high-dimensional space will be. A cosine value of 1 indicates perfect alignment (vectors point in the same direction), while a value of 0 indicates that the texts are unrelated (orthogonal vectors). This approach enables, for example, identifying texts that use different words for the same concept as similar—something that traditional text processing methods based on exact word matching cannot achieve.

Preferably, the degree of similarity between the content descriptions of two web pages is determined based on the cosine similarity of the vectors that represent the content of the two web pages. Cosine similarity is a measure of similarity between two vectors in space that is independent of their magnitude. It is frequently used in fields such as information retrieval, text mining, and machine learning to evaluate how similar two documents, sentences, or data points are in terms of their content or orientation when represented as vectors in a multidimensional space.

Cosine similarity is calculated by computing the cosine of the angle between two vectors. The value of the cosine similarity ranges from −1 to 1, where:
1 indicates that the vectors point in the same direction and are therefore fully similar,
0 means that the vectors are orthogonal (at a right angle) and thus unrelated, and
−1 signifies that the vectors point in exactly opposite directions.

Mathematically, cosine similarity is calculated using the dot product of the vectors and the norms (lengths) of those vectors. In the present context, cosine similarity is particularly useful because the magnitude of the vectors (e.g., determined by the length of a text document) is generally not relevant for assessing the similarity of web page content—only the direction of the vectors is important for determining semantic similarity.

It should be noted, however, that the invention is not limited to using cosine similarity. Other similarity measures between the content descriptions of two web pages are also available. Similarity between web page content can be quantified in various ways, each emphasizing different aspects of the data:

Cosine similarity is especially effective when measuring angles in high-dimensional vector spaces, making it ideal for text comparisons.

L2 distance (Euclidean distance) provides a direct measurement of geometric distance between points.

L1 distance (Manhattan distance) calculates the sum of absolute differences between coordinates and is more robust to outliers.

Inner product measures direct vector alignment, which can be useful in certain contexts.

Hamming distance, suitable for binary data, counts the number of differing bits.

Jaccard distance measures the similarity of sets, making it ideal for data represented as sets.

Each of these methods has its own advantages and is better suited depending on the structure of the web page data.

The invention also enables additional or alternative advertisements to be placed efficiently on web pages. For this purpose, according to a preferred embodiment of the invention, instead of or in addition to the continued use of the advertisement on the plurality of web pages of the web page group for which the higher number of clicks was recorded, a different advertisement is placed on the plurality of web pages of that group—provided that the content description of the new advertisement is at least to a predetermined degree similar to the content description of the previously used advertisement.

Again, the transformation of the advertisement's content is preferably carried out using a large language model to obtain a content description of the advertisement.

Just as with web pages, the content description of each advertisement is preferably obtained by assigning it a vector from a predetermined vector space, where linearly independent vectors represent advertisements whose content descriptions are not similar to each other. The degree of similarity between the content descriptions of two advertisements is preferably determined via the cosine similarity of the vectors representing the content of the two advertisements.

The invention will now be explained in further detail by way of a preferred embodiment with reference to the drawings.

In the drawings:

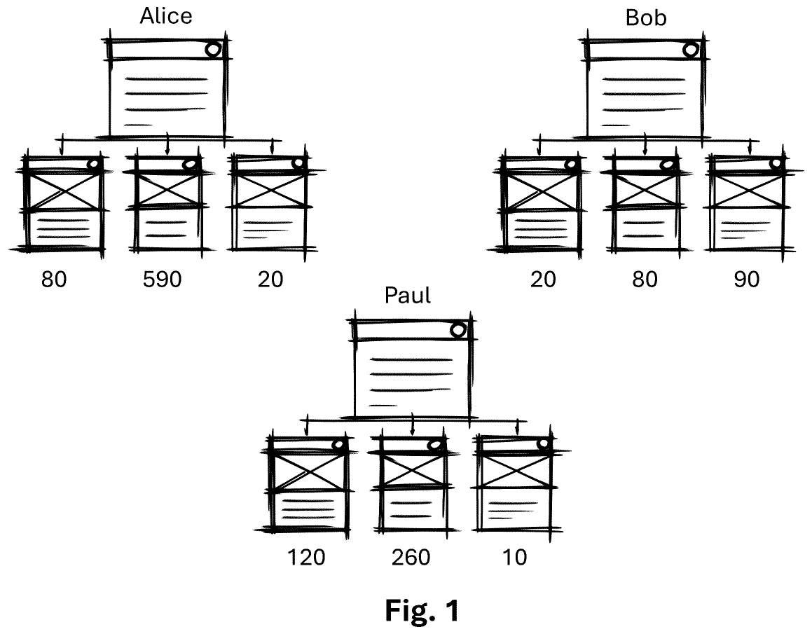

FIG. 1 schematically shows three different websites, each with three subpages, to which a method according to an embodiment of the invention can be applied,

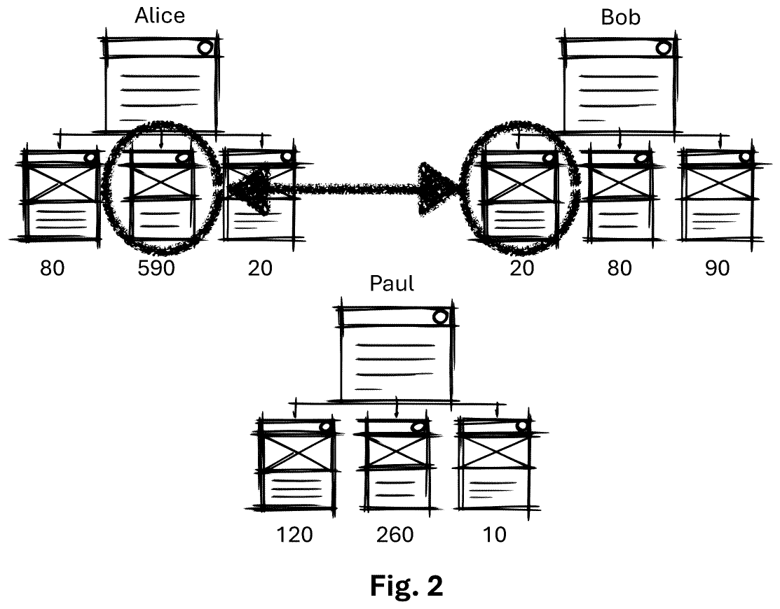

FIG. 2 schematically shows the grouping of two pages from the websites in FIG. 1 according to an embodiment of the invention,

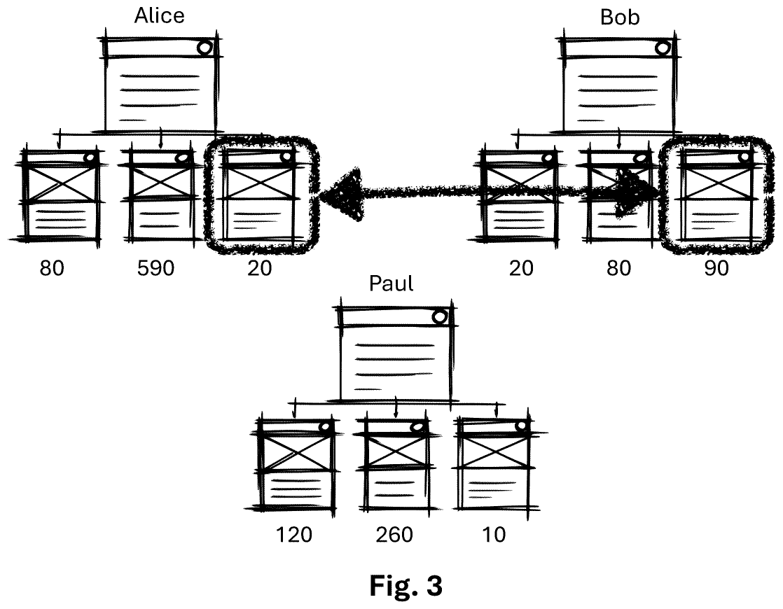

FIG. 3 schematically shows the grouping of two other pages from the websites in FIG. 1 according to an embodiment of the invention, and

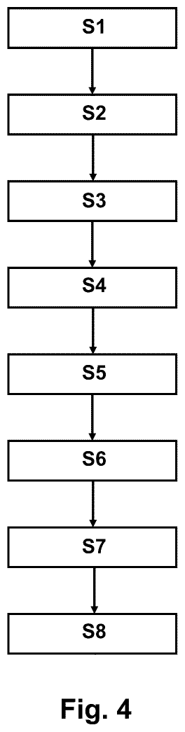

FIG. 4 schematically shows the sequence of a method according to an embodiment of the invention.

Often, individual subpages lack a sufficient number of visitors to allow for statistically meaningful conclusions about the effectiveness of the advertisements placed there. At the same time, for almost every topic of a subpage, there exist numerous other web pages with comparable content.

By forming virtual groups based on thematically closely related content and applying similar grouping strategies for advertisements, a broader assessment of advertisement effectiveness can be achieved. This method allows for effectiveness-related testing based on a broader data foundation, yielding more meaningful results.

This will now be illustrated with a preferred embodiment of the invention. There exist the following three websites, each having three subpages, schematically shown in FIG. 1:

### Website 1

### Owner: Alice

Subpage 1: Which cat cave is the best?—Visitors: 80
Subpage 2: Walking the dog—what to keep in mind?—Visitors: 590
Subpage 3: Why fish are the better pets!—Visitors: 20

### Website 2

### Owner: Bob

Subpage 1: 10 rules for walking man's best friend—Visitors: 20
Subpage 2: Top 10 spots for a dog walk—Visitors: 80
Subpage 3: Fish as Bello's best friend—Visitors: 90

### Website 3

### Owner: Paul

Subpage 1: 1 love fish! And so should you!—Visitors: 120
Subpage 2: Why cats are dangerous!—Visitors: 260
Subpage 3: Dogs are just okay. —Visitors: 10

Assuming that at least 100 visitors are needed to make a statistically relevant statement, only 3 of the 9 examples could be reasonably evaluated on their own. However, by combining thematically similar web pages into a virtual web page group and displaying the same advertisement across them, statistically valid conclusions can be drawn.

For instance, combining Subpage 2 of A lice with Subpage 1 of Bob, as shown in FIG. 2, allows for conclusions to be drawn regarding Subpage 1 of Bob—even though it has far fewer visitors (only 20 instead of the required 100). Grouping web pages with similar thematic content into a common virtual web page group thus enables such conclusions to be made.

The same applies to Subpage 3 of Alice and Subpage 3 of Bob, which can likewise be grouped into a shared virtual web page group, as shown in FIG. 3. Without such grouping, no conclusion about the effectiveness of the advertisements could be drawn for either page.

If multiple virtual groups are formed around a given topic, the effectiveness of multiple advertisements can be evaluated simultaneously. It is also possible to test multiple advertisements on the same page.

For example, Alice's second subpage has so many visitors that five advertisements can be tested at the same time. On Paul's second subpage, at least two advertisements can be tested simultaneously.

A similar type of grouping can also be performed for the advertisements themselves. If the content of an advertisement is known, similar advertisements can be tested for effectiveness in different groups to establish a relationship between advertisement and content. If the content is unknown, an advertisement can be randomly displayed within a virtual group, and its effectiveness compared with the known effectiveness of other advertisements. In this way, the similarity between unknown advertisements can also be determined.

Using this grouping method without user data has several significant advantages—especially considering that conventional systems typically require the collection of very large amounts of personal data. Without such data collection, the following three main benefits arise:
1. Storage requirements are greatly reduced because personal data and its history no longer need to be stored. The new storage requirement correlates only with the number of web pages and is thus finite. In contrast, conventional methods maintain historical user behavior data that can potentially grow indefinitely.
2. The amount of working memory needed is significantly reduced due to the smaller volume of data to be processed.
3. The simplified data structure—as virtual groups are less structurally complex and more uniform than heterogeneous tracking events with arbitrary personal data—also simplifies processing and thus significantly accelerates computation.

No information about the visitors themselves is required. It is sufficient to have data about the display of the advertisements and their success. Based on the collected data, advertisements can be selected for visitors of a specific subpage in such a way that the success rate of the advertisement is particularly high. The accuracy of ad placement increases with each additional display and user interaction—or lack thereof. The selection criterion used here is the effectiveness of an advertisement within a virtual group. Accordingly, a successful advertisement can be shown on all subpages that are part of the corresponding virtual web page group. It is also possible to make predictions for new subpages. By calculating the similarity or affiliation with existing virtual groups, advertisements can be placed successfully without further testing.

With reference to the flowchart in FIG. 4, a corresponding computer-implemented method for placing an advertisement on a web page is described as follows:

In step S1, a portion of the content of a plurality of web pages is captured using a web crawler.

In step S2, the captured content of the web pages is transformed using a large language model in order to obtain a content description of each respective web page. The content description of a web page is represented by assigning it a vector from a predetermined vector space, where linearly independent vectors represent web pages whose content descriptions are not similar to one another.

In step S3, web page groups are created, containing web pages with content descriptions that are similar to each other to at least a predetermined degree. The similarity is determined based on the cosine similarity between the vectors representing the content of the respective web pages.

In step S4, the same advertisement is placed on a plurality of web pages from a first web page group and a second web page group.

In step S5, the number of clicks on the advertisement on the web pages of the first web page group and the second web page group is captured over a predetermined period.

In step S6, the number of clicks on the advertisement across the first web page group is compared with the number of clicks across the second web page group.

In step S7, the advertisement is continued on the web pages of the group with the higher click count and discontinued on the web pages of the group with the lower click count.

It is essential that Steps S4 to 57, that is, placing the same advertisement on a plurality of web pages from a first web page group and a second web page group, capturing the number of clicks on the advertisement on the web pages of the first web page group and the second web page group over a predetermined period, comparing the number of clicks on the advertisement across the first web page group with the number of clicks across the second web page group, and continuing the advertisement on the web pages of the group with the higher click count and discontinuing on the web pages of the group with the lower click count, are always carried out exactly pairwise for a plurality of web pages.

An additional Step S8 may be incorporated into the method. According to this step, instead of or in addition to the continued use of the advertisement on the plurality of web pages of the web page group with the higher number of clicks, a different advertisement is placed on the same group of web pages—provided that the content description of this new advertisement is at least to a predetermined degree similar to the content description of the previously used advertisement. To obtain a content description of an advertisement, the content of the advertisement is transformed using a large language model. The content description of each advertisement is obtained by assigning it a vector from a predetermined vector space, in which linearly independent vectors represent advertisements whose content descriptions are not similar to one another. The degree of similarity between two advertisements is then determined via the cosine similarity between the vectors representing their content.

Finally, the technical advantages of the present invention over conventional systems—such as Google AdSense—shall be highlighted once more. One of the key effects lies in the drastic reduction of data volume while maintaining high efficiency. While Google AdSense collects up to 70 different data points per user, the present invention preferably works with just three core data points: the context, the number of ad impressions, and the clicks on the ad.

This reduces the amount of data to be stored to about five percent of the storage capacity required by AdSense. This data reduction not only significantly lowers storage requirements, but also minimizes data protection risks, since no personal information is processed.

Another decisive advantage is the significantly lower memory demand. While Google AdSense stores approximately 1.26 terabytes of data daily in Germany alone, and a multiple of that worldwide, the invention—in a preferred embodiment—requires only about 0.06 terabytes. This reduction not only lowers infrastructure costs, but also significantly reduces energy consumption.

Furthermore, the invention greatly improves data processing speed. Analyzing large amounts of data is traditionally a time- and resource-intensive process. While the loading time of AdSense data on conventional CPU servers exceeds 18 hours, the data processing according to the invention can be performed on a GPU in just four seconds. This allows not only for faster ad processing but also improves the overall efficiency of ad delivery. Due to the drastically reduced data volume and enhanced processing, the invention also requires less powerful hardware. This results in lower acquisition and operating costs as well as longer server lifespans. At the same time, energy consumption is reduced, which provides not only economic but also environmental benefits.

Overall, the invention offers a more sustainable, more efficient, and more cost-effective alternative to conventional, data-intensive online advertising—particularly due to its faster processing, lower hardware requirements, and significant storage savings.

1. A computer-implemented method for placing an advertisement on a web page, comprising the following steps:
(S1) capturing at least a portion of the respective content of a plurality of web pages;
(S2) transforming the captured content of the web pages to obtain a content description of each respective web page;
(S3) creating web page groups that contain web pages with content descriptions that are similar to each other to at least a predetermined degree;
(S4) placing the same advertisement on a plurality of web pages of a first web page group and a second web page group;
(S5) capturing the number of clicks on the advertisement across the plurality of web pages of the first and second web page groups within a predetermined time period;
(S6) comparing the number of clicks on the advertisement across the web pages of the first web page group with those of the second web page group; and
(S7) continuing to use the advertisement on the web pages of the web page group with the higher number of clicks and discontinuing its use on the web pages of the group with the lower number of clicks.

2. The method according to claim 1, wherein steps (S4) to (S7) are performed at least pairwise for a plurality of web pages.

3. The method according to claim 1, wherein the transformation in step (S2) is carried out using a large language model.

4. The method according to claim 1, wherein each web page is assigned a vector from a predetermined vector space, in which linearly independent vectors represent web pages whose content descriptions are not similar to one another.

5. The method according to claim 4, wherein the similarity measure between content descriptions is based on the cosine similarity of the vectors representing the content of the two web pages.

6. The method according to claim 1, further comprising:
(S8) instead of or in addition to continuing to use the advertisement on the web pages of the group with the higher number of clicks, placing an alternative advertisement on said web pages, wherein the content description of the alternative advertisement is similar—to at least a predetermined degree—to the content description of the previously used advertisement.

7. The method according to claim 6, wherein a large language model is used to transform the content of the alternative advertisement to obtain a content description.

8. The method according to claim 7, wherein the alternative advertisement is assigned a vector from a predetermined vector space, in which linearly independent vectors represent advertisements whose content descriptions are not similar to one another.

9. The method according to claim 8, wherein the similarity between the content descriptions of two advertisements is determined using cosine similarity.

10. A non-transitory computer-readable storage medium containing instructions which, when executed by a processor, cause the processor to perform the method according to claim 1.

11. A computer-implemented method for placing an advertisement on a web page, comprising the following steps:
(S1) capturing at least a portion of the respective content of a plurality of web pages;
(S2) transforming the captured content of the web pages to obtain a content description of each respective web page;
(S3) creating web page groups that contain web pages with content descriptions that are similar to each other to at least a predetermined degree;
(S4) placing the same advertisement on a plurality of web pages of a first web page group and a second web page group;
(S5) capturing the number of clicks on the advertisement across the plurality of web pages of the first and second web page groups within a predetermined time period;
(S6) comparing the number of clicks on the advertisement across the web pages of the first web page group with those of the second web page group; and
(S7) continuing to use the advertisement on the web pages of the web page group with the higher number of clicks, and discontinuing its use on the web pages of the group with the lower number of clicks, wherein
steps (S4) to (S7) are performed at least pairwise for a plurality of web pages, and
each web page is assigned a vector from a predetermined vector space, in which linearly independent vectors represent web pages whose content descriptions are not similar to one another.

12. A non-transitory computer-readable storage medium containing instructions which, when executed by a processor, cause the processor to perform the method according to claim 11.

13. A computer-implemented method for placing an advertisement on a web page, comprising the following steps:
(S1) capturing at least a portion of the respective content of a plurality of web pages;
(S2) transforming the captured content of the web pages to obtain a content description of each respective web page;
(S3) creating web page groups that contain web pages with content descriptions that are similar to each other to at least a predetermined degree;
(S4) placing the same advertisement on a plurality of web pages of a first web page group and a second web page group;
(S5) capturing the number of clicks on the advertisement across the plurality of web pages of the first and second web page groups within a predetermined time period;
(S6) comparing the number of clicks on the advertisement across the web pages of the first web page group with those of the second web page group;
(S7) continuing to use the advertisement on the web pages of the web page group with the higher number of clicks, and discontinuing its use on the web pages of the group with the lower number of clicks; and
(S8) instead of or in addition to continuing to use the advertisement on the web pages of the group with the higher number of clicks, placing an alternative advertisement on said web pages, wherein the content description of the alternative advertisement is similar—to at least a predetermined degree—to the content description of the previously used advertisement.

14. A non-transitory computer-readable storage medium containing instructions which, when executed by a processor, cause the processor to perform the method according to claim 13.
